(19) United States
(12) Patent Application Publication
(10) Pub. No.: US 2002/0170528 A1
(43) Pub. Date: Nov. 21, 2002

(54) Common rail system

(76) Inventors: Wilhelm Polach, Moeglingen (DE); Friedrich Boecking, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/069,731

(22) PCT Filed: Jun. 12, 2001
(86) PCT No.: PCT/DE01/02179

(30) Foreign Application Priority Data
Jun. 29, 2000 (DE) 100 31 733.2

(51) Int. Cl. F02B 53/00

(52) U.S. Cl. 123/200

(57) ABSTRACT

The invention relates to a common rail system for supplying fuel to internal combustion engines, in particular Diesel engines of passenger cars, having a central high-pressure fuel reservoir (4), which via high-pressure fuel lines (5, 7) communicates with a plurality of injectors, whose opening and closing motions are controlled each by a respective control device (13; 17, 19).

In order to furnish a common rail system that is suitable for vehicle engines, the high-pressure fuel reservoir (4) and the control devices (13; 17, 19) are combined in a module, which communicates permanently with the injectors via high-pressure fuel lines (8, 48).

### PRIOR ART

The invention relates to a common rail system for supplying fuel to internal combustion engines, in particular Diesel engines of passenger cars, having a central high-pressure fuel reservoir, which via high-pressure fuel lines communicates with a plurality of injectors, whose opening and closing motions are controlled each by a respective control device.

In common rail injection system, a high-pressure pump, optionally with the aid of a prefeed pump, pumps the fuel to be injected from a fuel tank into the central high-pressure fuel reservoir, which is known as a common rail. From the rail, fuel lines lead to the individual injectors, which are assigned to the cylinders of the engine. The injectors are triggered individually as a function of the engine operating parameters with the aid of a control unit, so as to inject fuel into the combustion chamber of the engine.

From German Patent Disclosure DE 197 01 879, a fuel injection system for large Diesel engines is known in which the control valve is disposed on each injector. The injectors with a control valve occupy a relatively large amount of space, which as a rule is scarce in motor vehicles.

The object of the invention is to furnish a common rail injection system of the type described at the outset that assures exact control of both the injection time and the injection quantity and is suitable for vehicle engines. Furthermore, the fuel injection system of the invention should be simple in design and capable of being manufactured economically.

A common rail system for supplying fuel to internal combustion engines, in particular Diesel engines of passenger cars, having a central high-pressure fuel reservoir, which via high-pressure fuel lines communicates with a plurality of injectors, whose opening and closing motions are controlled each by a respective control device. This object is attained by combining the high-pressure fuel reservoir and the control devices in a module, which communicates permanently with the injectors via high-pressure fuel lines.

### ADVANTAGES OF THE INVENTION

The module can be installed as a whole. The modular combination of the high-pressure fuel reservoir with control devices offers the advantage, over the convention assembly of individual components on the engine, that a complete calibration of the common rail system independently of the engine is made possible. As a result, the variations from one injector to another can be sharply reduced. The limitation in the variations can be done by way of the triggering or by mechanical or hydraulic adaptation. In addition, the line courses to be spanned are much shorter than in conventional systems. A large number of plugs can also be eliminated.

A particular embodiment of the invention is characterized in that at least one sensor is integrated with the module. The sensor can also be premounted, which greatly simplifies the assembly and installation of the common rail system of the invention. The sensors are for instance sensors for examining the exhaust gases or the charge air. Rail pressure sensors can also be integrated with the module.

A further particular embodiment of the invention is characterized in that the control device includes a first control valve member, which is received axially displaceably in the module between an opened position, in which a communication between the high-pressure fuel reservoir and the triggered injector is opened, and a closed position, in which the communication between the high-pressure fuel reservoir and the respective injector is closed, as a function of the pressure in a control chamber, and a second axially displaceable control valve member, received in the module, which opens a communication between the control chamber and a pressureless return as a function of the position of an axially displaceable actuator, in particular a piezoelectric actuator, and that the axes of the first control valve member, the second control valve member and the actuator are each disposed at a right angle to one another. The result is an extremely compact, pressure-controlled common rail injection system that requires only little installation space.

A further special embodiment of the invention is characterized in that conventional nozzle holder combinations are used as injectors. Conventional nozzle holder combinations have the advantage of being more economical to produce than pressure-controlled common rail injectors.

In an internal combustion engine having a cylinder head and a cylinder head cap, the aforementioned object is attained in that a module as described above is mounted between the cylinder head and the cylinder head cap. The resultant compact design makes for an attractive appearance of the engine.

Further advantages, characteristics and details of the invention will become apparent from the ensuing description, in which an exemplary embodiment of the invention is described in detail in conjunction with the drawing. The characteristics recited in the claims and in the description can each be essential to the invention. individually or in arbitrary combination with one another.

### DRAWING

Shown in the drawing are:

FIG. 1, the elevation view of a longitudinal section through a common rail system of the invention; and

FIG. 2, the elevation view of a section taken along the line II-II of FIG. 1.

### DESCRIPTION OF THE EXEMPLARY EMBODIMENT

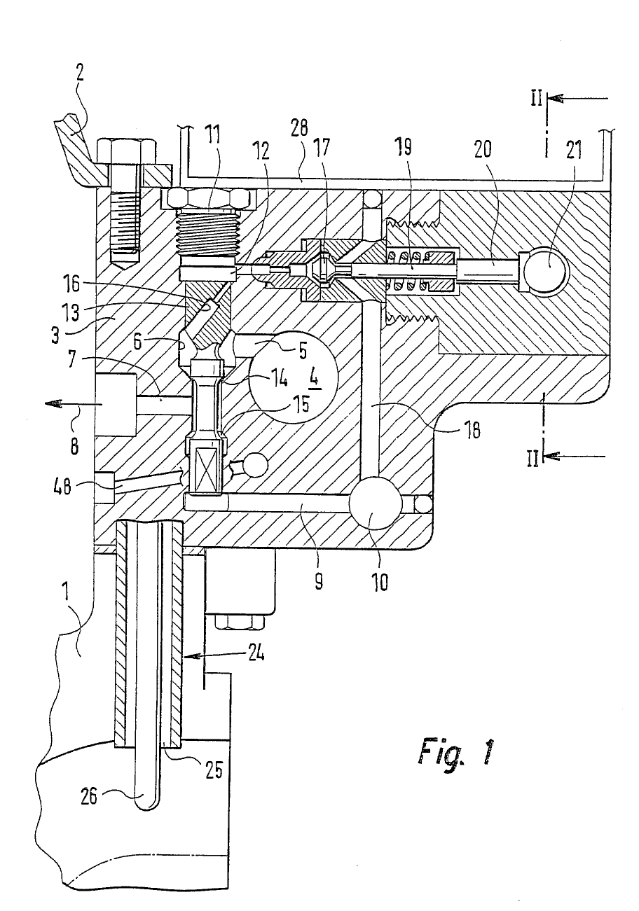

In FIG. 1, a detail of a cylinder head 1 of a motor vehicle engine is seen. The top of the cylinder head 1 is covered by a cylinder head cap 2. Disposed between the cylinder head cap 2 and the cylinder head 1 is a module 3 of a common rail fuel injection system.

A central high-pressure fuel reservoir 4 is embodied in the module 3. The high-pressure fuel reservoir 4 takes the form of a bore, which extends into the plane of the drawing. A high-pressure fuel conduit 5 extends from the high-pressure fuel reservoir 4. The high-pressure fuel conduit 5 discharges into a bore 6, whose longitudinal axis is disposed perpendicular to the longitudinal axis of the high-pressure fuel reservoir 4.

A high-pressure conduit 7 is extends from the valve bore 6. Through the high-pressure conduit 7, fuel subjected to high pressure flows out of the high-pressure fuel reservoir 4 to an injection nozzle, represented by an arrow 8. A return from the injection nozzle (not shown) is marked 48.

Also extending from the valve bore 6 is a low-pressure conduit 9, which discharges into a return rail 10. The low-pressure conduit 9 is disposed at the end of the valve bore 6, which in turn is embodied as a blind bore. The open end of the valve bore 6 is closed by a closure stopper 11. The closure stopper 11 defines a control chamber 12. On the opposite side, the control chamber 12 is defined by the end face of a first control valve member 13, which is received axially displaceably in the valve bore 6. The control chamber 12 communicates through a connecting conduit 16, which extends obliquely through the first control valve member 13, with the orifice region of the high-pressure fuel conduit 5. A first sealing face 14 and a second sealing face 15 are also embodied on the first control valve member 13. Depending on which of the sealing faces 14 and 15 is in contact with its associated seat, the communication between the high-pressure fuel reservoir 4 and the high-pressure conduit 7 to the injection nozzle is either opened or closed.

The axial motion of the first control valve member 13 is controlled via the pressure in the control chamber 12. Through the connecting conduit 16, fuel subjected to high pressure flows out of the high-pressure fuel reservoir 4 into the control chamber 12.

When a valve ball 17 lifts from its seat, a communication is opened between the control chamber 12 and a low-pressure conduit 18. As a consequence, the pressure in the control chamber 12 drops, and the communication between the high-pressure fuel reservoir 4 and the high-pressure conduit 7 is opened by the first control valve member 13. The valve ball 17 is secured to the end of a rod 19. The rod 19 together with the valve ball 17 forms a second control valve member. The longitudinal axis of the second control valve member is disposed perpendicular to the longitudinal axis of the first control valve member 13.

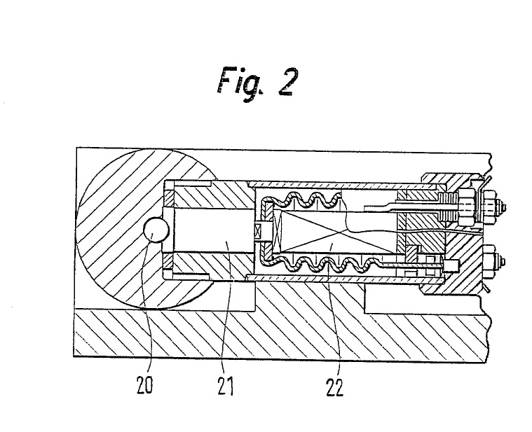

The second control valve member is coupled via a first booster piston 20 and a second booster piston 21 to a piezoelectric actuator 22, which is shown in FIG. 2. The second control valve member 17,19 and the first booster piston 20 are disposed on the same longitudinal axis. The second booster piston 21 is disposed perpendicular thereto, being disposed on the same longitudinal axis as the piezoelectric actuator 22.

Finally, a sensor 24 is integrated with the module 3. The sensor 24 has an annular chamber 25 for measuring the charge pressure. The sensor 24 also has a probe 26 for temperature measurement.

A control unit 28 is mounted on the top of the module 3, as indicated in FIG. 1.

1. A common rail system for supplying fuel to internal combustion engines, in particular Diesel engines of passenger cars, having a central high-pressure fuel reservoir (4), which via high-pressure fuel lines (5, 7) communicates with a plurality of injectors, whose opening and closing motions are controlled each by a respective control device (13; 17, 19), characterized in that the high-pressure fuel reservoir (4) and the control devices (13; 17,19) are combined in a module, which communicates permanently with the injectors via high-pressure fuel lines (8, 48).

2. The common rail system of claim 1, characterized in that at least one sensor (24) is integrated with the module (3).

3. The common rail system of one of the foregoing claims, characterized in that the control device includes a first control valve member (13), which is received axially displaceably in the module (3) between an opened position, in which a communication between the high-pressure fuel reservoir (4) and the triggered injector is opened, and a closed position, in which the communication between the high-pressure fuel reservoir (4) and the respective injector is closed, as a function of the pressure in a control chamber (12), and a second axially displaceable control valve member (17, 19), received in the module (3), which opens a communication between the control chamber (12) and a pressureless return (18) as a function of the position of an axially displaceable actuator (22), in particular a piezoelectric actuator, and that the longitudinal axes of the first control valve member (13), the second control valve member (17, 19) and the actuator (22) are each disposed at a right angle to one another.

4. The common rail system of one of the foregoing claims, characterized in that conventional nozzle holder combinations are used as injectors.

5. An internal combustion engine, having a cylinder head (1) and a cylinder head cap (2), characterized in that a module (3) of one of the foregoing claims is mounted between the cylinder head (1) and the cylinder head cap (2).
